(19) United States
(12) Patent Application Publication
(10) Pub. No.: US 2018/0109623 A1
(43) Pub. Date: Apr. 19, 2018

(54) SECURE CONTROLLING OF VEHICLE COMPONENTS IN A TELECOMMUNICATION NETWORK

(71) Applicant: Robert Bosch GmbH, Stuttgart (DE)

(72) Inventors: Jan Zibuschka, Magstadt (DE); David Foerster, Ludwigsburg (DE); Hans Loehr, Stuttgart (DE)

(21) Appl. No.: 15/722,420

(22) Filed: Oct. 2, 2017

(30) Foreign Application Priority Data
Oct. 17, 2016 (DE) 102016220231.6

(51) Int. Cl. H04L 29/08; H04W 12/06; H04W 4/04

(52) U.S. Cl. CPC H04L 67/125; H04W 4/046; H04W 12/06

(57) ABSTRACT

A telecommunication network, an authentication node, and a method for commissioning an electronically controllable vehicle component of a telecommunication network. For commissioning, the vehicle component requires a verification of authentication data that are to be acquired. For this purpose, the following is carried out: positioning a mobile data carrier in the authentication node of the traffic network, in particular in a vehicle; reading in authentication data of the mobile data carrier within the authentication node; verifying the read-in authentication data and, if verification is successful: producing a verification signal; triggering a verified commissioning of the component if the verification signal is acquired at the vehicle component or at a control device of the node at which the component is situated.

### CROSS REFERENCE

The present application claims the benefit under 35 U.S.C. § 119 of German Patent No. DE 102016220231.6 filed on Oct. 17, 2016, which is expressly incorporated herein by reference in its entirety.

### FIELD

The present invention is in the areas of network technology and traffic technology, and relates in particular to a traffic-related telecommunication system, an authentication node of such a system, and a method for commissioning a component of a network node.

In the area of traffic-related communication, in particular Car2X communication, vehicle components are increasingly controlled electronically and networked among one another. Here, transmitted data also include private data, i.e., data requiring the maintenance of secrecy, that are to be protected against unauthorized access. For this reason, it is increasingly important to take into account the security of the data exchange in the implementation of the systems.

Conventionally, so-called credentials are used as an authentication data set for secure communication. The implementation of credential systems on smart cards is also conventional. Idemix (identity mixer) is an example of an anonymous credential system that works with pseudonyms. On this, see the paper by Bichsel et al.: Bichsel, P., Camenisch, J., Gross, T., and Shoup, V. (November 2009), “Anonymous credentials on a standard Java card,” in: Proceedings of the 16^{th} ACM conference on computer and communications security (pp. 600-610), ACM.

In these conventional systems, it is disadvantageous that the private sphere of the communication partners is inadequately protected. Inference back to the identity of a vehicle user should for example be impossible for external infrastructure nodes with which the vehicle interacts.

With the aid of anonymity services, in principle a profile formation based on the connection data of a user can be avoided. However, anonymity services are not suitable for protecting privacy when using personalized functions and services such as the personalized commissioning of vehicle components.

A further disadvantageous aspect relates to the protected commissioning of components of the known Car2X communication systems. The operating components of a vehicle (radio, navigation system, communication system, etc.) in the existing art are automatically in an operating mode when the driver has identified himself or herself (e.g., by inserting the key, or some other proof of identification). As a result, it is disadvantageously not possible to cover cases of use that require the user to authenticate himself or herself directly in relation to selected dedicated components before they can be put into operation in the vehicle or at an infrastructure node (e.g. a gate, a traffic light, etc.), even if the driver has identified him/herself to the vehicle itself. This is a safety risk.

### SUMMARY

An object of the present invention is to provide a path by which a secure and verified commissioning of components of a vehicle or of an infrastructure node is possible. In addition, the commissioning of the components of a traffic-related network is to be improved.

This object may be achieved in accordance with the present invention, by providing a telecommunication network, an authentication node, and a method for commissioning a component of a traffic network.

Below, the present invention is described on the basis of the solution relating to the method, and is thus described on the basis of the method for commissioning an electronically controllable component. Features, advantages, or alternative specific embodiments described here apply to other embodiments. In other words, features directed to, for example, a system or to a node, can also be further developed with the features that are described in relation to the method. The corresponding functional features of the method are here realized by corresponding objective modules, in particular electronic hardware modules, in particular microprocessor modules, of the system, and vice versa. Likewise, described aspects of the system can be carried over to the method through realization or application of the functional aspects.

According to an aspect of the present invention, a method is provided for commissioning an electronically controllable component, e.g. a vehicle component, of a telecommunication network in the area of traffic technology, the component requiring, for commissioning, a verification of authentication data that are to be acquired, and the component being situated at a node of the traffic network, having the following method steps:
positioning of a mobile data carrier in an authentication node of the traffic network, in particular in a vehicle;
reading in of authentication data that are stored on the mobile data carrier in the authentication node;
verification of the read-in authentication data and, given successful verification: production of a verification signal;
triggering of a verified commissioning of the component if the verification signal is acquired at the component or at a control device of the node at which the component is situated.

The present invention is directed to the use of a credential-based controlling and commissioning of dedicated components of a vehicle or of a traffic-related node.

Below, the terminology used in the present application is explained and the present invention is described in further detail.

The component is an electrical, mechatronic, and/or electronic part that can be situated in a vehicle or in an infrastructure node such as a traffic light, a construction site sign, or an entrance gate. The component can be controlled electronically, and for this purpose can be fashioned for example via a bus system having corresponding communication interfaces. The component can also be situated in the vehicle and fashioned for example as a navigation system or as a communication device for communication with external devices (e.g., devices at foreign nodes). The component is intended for the execution of a technical function. The component requires, for its commissioning, a verification of authentication data that are to be acquired. In other words, the component is distinguished in that it can be put into operation, or activated, only when the verification of the authentication data has successfully been carried out. The component can be a part in a vehicle or in a node of the traffic network that has a corresponding communication interface. The component can provide a particular driving-related function (e.g., receive traffic radio signals), or can carry out a driving-related job (e.g. navigation). The component can also be used for wireless communication with a remote component, where the remote component and the component can be, but do not have to be, situated at different nodes of the telecommunication network.

The telecommunication network is a network for the transmission of digital and/or analog data. The telecommunication network can be fashioned for communication between different nodes as a wireless network. The telecommunication network can include subordinate networks that can be operated partly in a different technology (e.g. as a vehicle-internal, wire-bound network, such as a LAN, or local area network). For communication with mobile units, a wireless network is used. As radio network, for example a GSM network (Global System for Mobile Communications), UMTS network (Universal Mobile Telecommunications System), LTE network (Long-Term Evolution network), or a WLAN (wireless local area network), or some other wireless network system, can be used. The WLAN network can be based on the IEEE 802.11 standard. Different protocols can be used. A bus system can be used as a wire-bound network, in particular as a network within a node, such as within the vehicle node. The bus system can be for example a FlexRay bus, a MOST bus, a TT-CAN bus, or a LIN bus.

Alternatively, or cumulatively, IP-based bus systems can also be used.

The authentication data can be a digital data set transmitted according to a particular protocol. The authentication data can in particular include an anonymous credential. Anonymous credentials are a means for preventing the chainability of the information. Using the credential (which acts, so to speak, as a digital proof), a user can authorize him/herself to a system. A credential system is anonymous if transactions carried out by one and the same user cannot be changed. The credential represents so to speak data that identify the user, via which an access, intended by the user, to a component can be permitted or refused. For the technical realization of the authentication data, with the corresponding protocols, in a first specific embodiment of the present invention a Camenisch-Lysyanskaya system can be used. In a second specific embodiment of the present invention, a Brands credential system can be used. For further details concerning the communication protocols, see the publication by Bichsel et al.: Bichsel, P., Camenisch, J., Gross, T., and Shoup, V. (November 2009), “Anonymous credentials on a standard Java card,” in: Proceedings of the 16^{th} ACM conference on computer and communications security (pp. 600-610), ACM. Further concrete implementation possibilities are to be found in Gregory Neven, “A quick introduction to anonymous credentials,” https://idemix.wordpress.com/2009/08/18/quick-intro-to-credentials/.

The mobile data bearer includes a memory and can be fashioned for example as a smart card or as a chip card. A chip card or integrated circuit card (ICC) is a special plastic card having a built-in integrated circuit (chip) that contains a hardware logic, memory, or also a microprocessor. Chip cards are controlled by special card reading devices.

The node is an electronic module, an actuator or an electronic device in a telecommunication network in the area of traffic technology. The mode can in particular be a vehicle or an infrastructure node, such as a traffic light, an electrically operated gate, or a construction site display that can be controlled via communication interfaces. The node is intended to carry out a technical function (in the previous examples: traffic light function, opening/closing of the gate, display function).

The verification module can be implemented in hardware and/or in software. The verification module can be operated in two different modes: on the one hand, in the direct mode, in which the verification module acts as a verifier and is fashioned to verify the authentication data directly at the verification module. On the other hand, it can be operated in the indirect mode, in which the verification module acts as an interface to an external verifier, the external verifier being used for the verification of the authentication data. In this case, the verification module acts only indirectly as a verifier, and interacts with a third party (e.g., a certifying authority) via a communication interface.

The control device is an electronic component or a chip module that is used to control the components. The component is characterized in that, or is programmed in such a way that, it can be set into operation only when the acquired authentication data have been successfully verified. The control device is implemented on the node on which the component to be controlled is also situated. The control device can be intended for the reception of the verification signal and to activate the component in response thereto. If the verification module is situated on the same node as the component, the function of the control device can also be taken over directly by the verification module, so that no separate control device has to be provided.

The commissioning corresponds to an activation of the component. According to the object named above, it is to be ensured that the component can execute the implemented respective function, or be put into operation, only when the acquired authentication data have been successfully verified. Conventionally, a commissioning of components is available. There, however, this is an unchecked commissioning. In the solution provided herein, the commissioning takes place in a verified manner. In this way, it is ensured that the user is authenticated in dedicated fashion for the respective activation of the component. If the component is used for example for communication with instances external to the vehicle, then no communication can take place when verification is missing or has failed.

In a preferred specific embodiment of the present invention, a remote component (e.g., a receive device of another vehicle) can act directly as verification module when there is a communication with the remote component. For this purpose, the remote component has a verification module that is fashioned to verify authentication data transmitted to it for the operation of the component. For this purpose, it can access a memory in which reference data are stored.

Alternatively, the remote component can carry out the verification not directly, but rather indirectly, by interacting with an external verification module for the purpose of verification. This can be for example a so-called third-party authority (trusted third-party (TTP) or certificate authority (CA)).

According to a further advantageous specific embodiment of the present invention, the verification signal includes a trigger signal that triggers a technical action at the vehicle, at the component, and/or at a remote component. The trigger signal can for example be a control signal for an actuator of an electrically operated gate (gate opener, gate closer), or can be used to control other electrical or electronic equipment or components. This may have the advantage that, after successful verification, the technical component can automatically be put into operation without requiring further user inputs.

In an advantageous development of the present invention, it is provided that the component or the node on which the component is situated can remain deactivated or operated only in a limited mode if no verification signal can be produced or acquired. In this way, the security of the system can be increased by linking the execution of the respective technical function of the component to a successful verification.

In another advantageous development of the present invention, all authentication attempts and all verifications are stored in a memory. This has the advantage that the access attempts for commissioning the component can be supplied for a statistical evaluation. In addition, through further calculations possible security gaps can be better discovered.

In another advantageous development of the present invention, the verification of the read-in authentication data includes a comparison with stored, locked authentication data. The locked authentication data can be dynamically modified and represent authentication data for which no verification is possible. The locked authentication data can be stored for example in the form of a list in a memory.

According to an advantageous specific embodiment of the present invention, the verification of the read-in authentication data for the purpose of verified commissioning of the component includes the following method steps:
acquiring at least one identification attribute of the user via sensors (e.g. biometric data or PIN data), and
comparing the acquired identification attributes with reference values that are stored on the mobile data carrier.

It is possible that this identification attribute acquisition and its comparison with reference values acts as the actual and sole verification. In this case, a user would be able to verify his/her authentication data in that his/her biometric data are acquired and compared to reference values for agreement. It is also possible for this identification attribute acquisition, and its comparison with reference values, to be carried out as an additional measure, and thus parallel to verification using an anonymous credential. The acquisition of the biometric data or of the acquired identification attributes and its comparison with reference values are then executed as a kind of higher-level verification, and in addition to credential-based authentication, and contribute to the increased security of the method.

According to a further aspect, the object is achieved by a telecommunication network in the area of traffic technology having a multiplicity of nodes that are fashioned having a communication interface and can be controlled electronically via the interface,
at least one node being realized as an authentication node, in particular as a vehicle, at which a read unit is situated that is intended for the reading in of authentication data of a mobile data carrier, and
the telecommunication network including a verification module that exchanges data with the read unit and is intended to verify the authentication data read in by the read unit in order to produce a verification signal in the case of a successful verification,
at least one node being fashioned as a function node having a component that is to be controlled, the component being controlled in order to carry out a technical function when it has received the verification signal of the verification module.

The authentication node and the function node are two different realizations of a node of the telecommunication network. The authentication node is a node on which the read unit is situated and at which the authentication data are read in from the mobile data carrier. The function node is the node at which the component for carrying out the technical function is situated. It is therefore designated function node or functional node.

In an advantageous variant, the verification module is not situated at the authentication node (e.g., at the vehicle). It is also possible for the component not to be situated at the authentication node. It can also be that neither the verification module nor the component is situated at the authentication node, but rather at external nodes of the network. In this way, the verification module can be fashioned at an external verifier, and the component can be fashioned external to the vehicle as an electric gate or as an external communication partner at another vehicle.

In a variant of the present invention, the verification module and the component can be situated at different nodes. In these cases, the telecommunication network includes a control device that is situated at the same node as the component. The control device is set up to put the component into operation in a verified manner in response to the received verification signal.

In an advantageous realization of the telecommunication network, the verification module and the component are situated at the same node, in particular at the function node.

The object described above is also achieved by an authentication node of a traffic-related telecommunication network that can be fashioned in particular as a vehicle. The authentication node is fashioned having:
a read unit (e.g. in the form of a card reader) that is intended for the reading in of authentication data (e.g. of an anonymous credential) of a mobile data carrier (e.g. a smartcard), and having
a verification interface that is intended to send the authentication data read in by the read unit to a verification module, the verification module being intended to verify the sent authentication data for the operation of an electronically controllable component, and, in the case of a successful verification, to produce a verification signal that is used to put the electronically controllable component into operation in a verified manner.

In a preferred embodiment of the authentication node, the verification module is situated at the authentication node. In this way, the authentication node can act autarkically, and can carry out the verification directly at the authentication node. For this purpose, this node has a memory in which verification data are stored as a reference.

In a further preferred embodiment of the authentication node, the verification module and the component are situated at the authentication node. This relates to situations of use in which for example a dedicated vehicle component (a component selected from a set of components) first has to be subjected to an authentication process before commissioning.

In a further preferred embodiment of the authentication node, a control device is situated there that receives the verification signal of the verification module in order to put the component into operation in a verified manner in response to the received verification signal.

A further solution of the object provides a computer program for carrying out all method steps of the method described in more detail above when the computer program is executed on a computer or on an electronic device. Here it is also possible for the computer program to be stored on a medium readable for the computer or for the electronic device. The computer program can also be downloaded from a server. The computer program can also be provided as a computer program product and can include further elements in addition to the program (such as installation software and the like).

In the following detailed description of the Figures, exemplary embodiments, which are not to be understood as limiting, are discussed with their features and further advantages, on the basis of the Figures.

### BRIEF DESCRIPTION OF THE DRAWINGS

FIG. 1 shows, in a schematic overview, a distributed traffic network system having various nodes according to an advantageous specific embodiment of the present invention.

FIG. 2 shows the same as FIG. 1, according to another advantageous specific embodiment of the present invention.

FIG. 3 shows a schematic representation of a node fashioned as a vehicle.

FIG. 4 shows another network architecture, also in a schematic representation.

FIG. 5 in turn shows a further network architecture having an authentication node and a function node that are implemented on different constructive units.

FIG. 6 is a flow diagram for a method for commissioning a component according to an advantageous specific embodiment of the present invention.

FIG. 7 is a flow diagram in the form of a UML interaction diagram, having method steps that are carried out in distributed fashion at the respective node.

### DETAILED DESCRIPTION OF EXAMPLE EMBODIMENTS

Below, the present invention is described in more detail on the basis of exemplary embodiments in connection with the Figures.

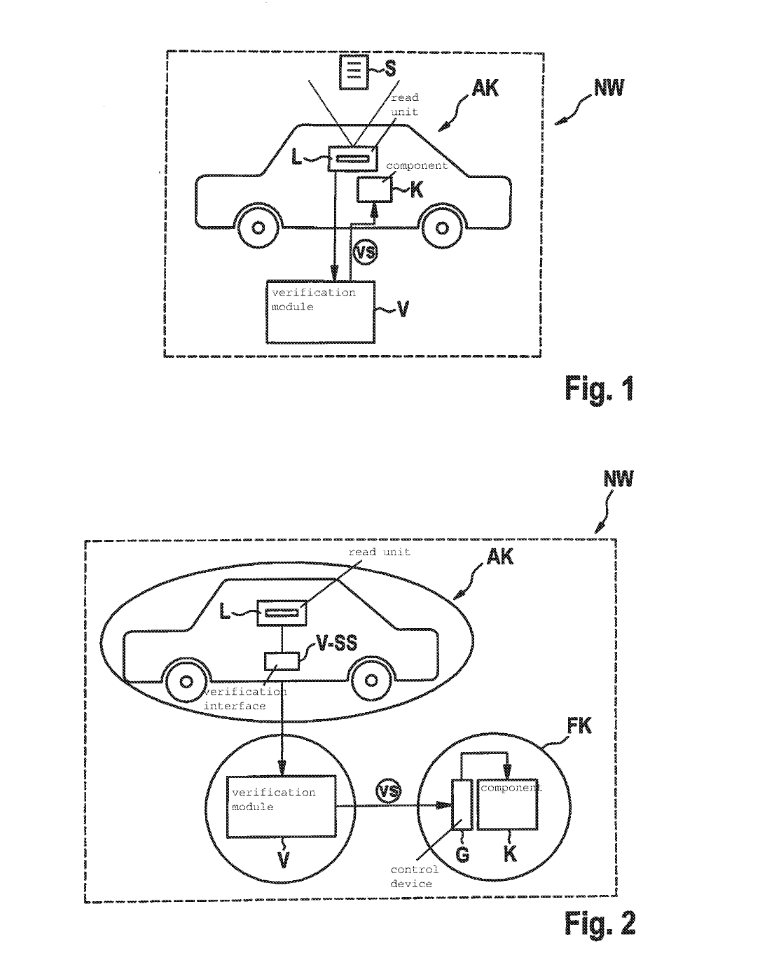

FIG. 1 shows a node of a traffic network NW that can be realized in particular as a vehicle. Of course, for someone skilled in the art it also lies within the scope of the present invention to include, in addition to motor vehicles, electric vehicles or other mobile traffic devices such as ships or aircraft in the network, and to realize them as authentication node AK.

For this purpose, authentication node AK is fashioned having a read unit L that, in a preferred specific embodiment of the present invention, can be realized as a card reader for smartcards. Card reader L is used to acquire authentication data that are stored on a mobile data carrier S such as a smartcard. After the user, or driver of the vehicle, has inserted his personally assigned smartcard S into read unit L, the authentication data stored thereon can be read out and acquired. These data are then sent to a verification module V for the purpose of verification. In the example shown in FIG. 1, verification module V is not situated in the vehicle or at authentication node AK, but rather at an external node. Verification module V is intended to verify the authentication data read in by the read unit in order to produce a verification signal vs in the case of a successful verification. Different protocols can be used for verification, such as Camenisch-Lysyanskaya and Brands credential systems. There are a number of variants of both systems; thus, Camenisch-Lysyanskaya credentials can be realized based on RSA estimation, LRSW estimation, or using Boneh-Boyen-Shacham group signatures. The details of the communication protocol are realized correspondingly. The systems have in common that, using one (or more) values on smartcard S, via a card reader L the proof that a particular attribute is true of the user can be demonstrated to a third party, verification module V, which can act as verifier, without this module obtaining further information, and without the respectively involved node (e.g. verification module V or a component K) being able to again recognize the user when the interface is used again.

When there is a successful verification, verification module V produces verification signal vs, which is transmitted to a component K directly or indirectly (e.g. through communication to a control device (not shown in FIG. 1)) via corresponding interfaces, and is used to activate components K and to set them into operation in a verified manner.

Component K is used to carry out a technical function. It can for example be a communication module for Car2X communication with instances external to the vehicle, a mechanical, electronic, and/or mechatronic component (e.g. a navigation system, or a vehicle-external instance (e.g. an entry barrier such as a gate that can be controlled via corresponding interfaces).

FIG. 2 shows a different network architecture of traffic-related telecommunication network NW for commissioning component K. Differing from the example shown in FIG. 1, in this embodiment an external function node FK is provided at authentication node AK and at verification module V. Authentication node AK, for example realized as a vehicle, includes, in addition to read unit L, a verification interface V-SS via which the read-in authentication data are sent to verification module V. In this case, verification module V is also not situated at authentication node AK, but rather is provided as a separate external constructive unit. Verification module V can be fashioned for example as a third party of a certification system. In the case of a successful verification, verification module V sends verification signal vs to function node FK at which component K to be controlled is situated.

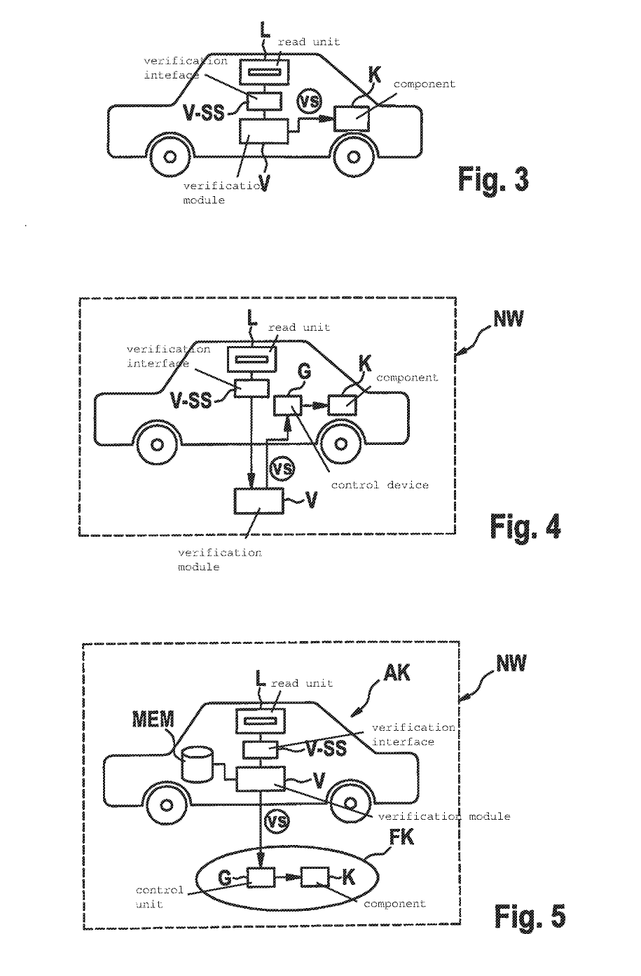

FIG. 3 represents the case in which all parts, instances, and components of the system are realized at authentication node AK. Thus, this node functions both as authentication node AK and as function node FK, because it includes component K that is to be controlled and in addition is also used for local verification, because verification module V is also realized at this node. Verification interface V-SS then forwards the read-in authentication data to verification module V only internally, within node AK. As is also the case in the other variants of the present invention, when there is a successful verification of the authentication data a verification signal vs is produced and is used for the controlling and verified commissioning of component K.

FIG. 4 shows an exemplary embodiment of the present invention that essentially corresponds to the architecture of the network system of FIG. 3, but in which verification module V is not realized inside authentication node AK (e.g. the vehicle). This architecture proves useful in particular when a certification instance is to be included in network NW.

In the variant shown in FIG. 5, differing from FIG. 4, it is not verification module V that is located outside authentication node AK, but rather only technical component K. Thus, verification module V is situated at authentication node AK and technical component K is situated outside authentication node AK. The verification of the authentication data can be carried out directly at authentication node AK without requiring an external communication outside authentication node AK. For this purpose, at authentication node AK a memory MEM is provided on which certification data are stored. Function node FK, with technical component K, is situated elsewhere, and can be situated for example at a different vehicle or a different constructive unit (construction site unit, traffic node, such as a traffic signal, etc.). In the case of a successful verification, verification module V sends the produced verification signal vs to function node FK. A control device can be provided for the controlling of component K at function node FK. Control device G is used to acquire verification signal vs and, in response thereto, for the automatic and verified controlling and commissioning of component K.

Preferably, a control device G is provided in the cases in which verification module V and component K are situated at different nodes of the network. This specific embodiment has the advantage that costs can be saved and fewer resources have to be used, because verification module V takes over the function of control device G. An additional control device G is preferably not provided in the specific embodiment shown schematically in FIG. 3. In FIG. 2, verification module V can take over the function of control device G, in particular when it is also implemented on function node FK, as is component K. Otherwise (that is, when verification module V is implemented on a different node then components K), it is of course also possible to realize an additional control functionality thereon, so that it externally controls component K at a remote node. For this purpose, a suitable protocol for data exchange is installed.

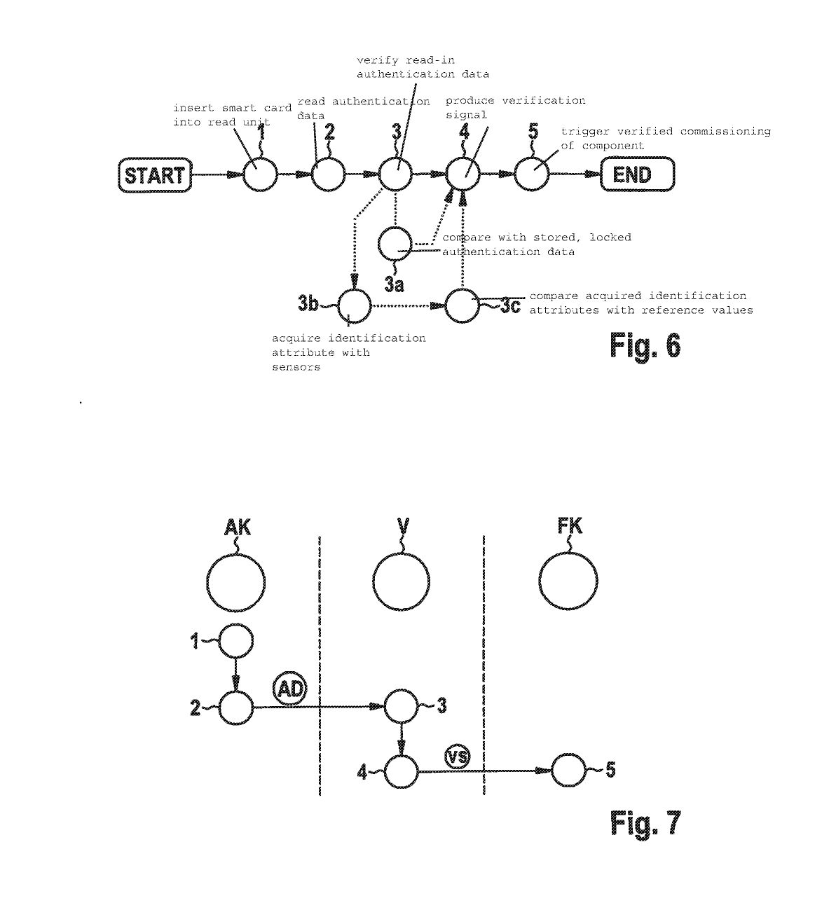

In FIG. 6, a flow diagram is shown for a method for commissioning the electronically controllable component K of traffic-related telecommunication network NW. Component K is distinguished in that for commissioning it requires a verification of authentication data that are to be acquired, and that it is situated at the node of the traffic network.

After the start of the method, in step 1 mobile data carrier S is positioned in the authentication node of the traffic network, in particular in a vehicle. Preferably, the mobile data carrier, in particular a smart card S, is inserted into read unit L. In step 2, the authentication data of mobile data carrier S can then be read in in authentication node AK, in particular by read unit L. In step 3, the verification of the read-in authentication data takes place. If the verification is successful, then in step 4 a verification signal vs is produced. This is preferably carried out directly at the verification module. In step 5, in the case of a successful verification, a verified commissioning of component K is triggered or initiated, i.e. if it was possible to acquire verification vs at component K or at a control device G of node FK at which component K is situated. Subsequently, the method can terminate or can be applied again. As is indicated in FIG. 6 by the dotted arrows, the method can alternatively also include, in step 3a, a comparison with stored, locked authentication data (locking data, which can be provided for example in the form of a blacklist). The verification then also includes the comparison with the locking data. If the read-in authentication data of mobile data carrier S agree with the locking data (stored as a reference data set), no verification signal vs is produced, and component K cannot be put into operation, or, depending on the pre-configuration, can be put into operation only in a limited mode.

In a further variant of the present invention, it is possible for the verification of the read-in authentication data to include an acquisition 3b of at least one identification attribute of the user via sensors. The sensors are situated in authentication node AK, and can be used for the acquisition of e.g. biometric data or PIN data. In addition, the verification includes a comparison 3c of the acquired identification attributes with reference values that are stored on mobile data carrier S. If the comparison is positive, the previous positive verification can be confirmed; otherwise, an error message must be outputted. Steps 3a and 3b and 3c can also be combined in a specific embodiment.

In a first variant, a credential-based verification can thus first be carried out. If its result is positive, and the user can thus successfully be verified for commissioning of component K, then in later steps 3b, 3c a higher-level verification, or further checking of the verification, can be carried out by changing over to a different verification mode. Here, the digital authentication data based on the anonymous credential are not calculated; rather, other, partly analog data, such as image data, biometric data, or a numeric identification number (e.g. a PIN number) are used. Component K can be put into operation only when this additional verification test has been successfully concluded. In this way, the security of the system and of the method can be increased.

It is also possible for the different verification modes:
1. Credential-based verification using the authentication data stored on mobile data carrier S (type 1 verification), and
2. Sensor-based verification using sensors for the acquisition of identification attributes (type 2 verification) to each be assigned to a different functional scope or operating scope of component K. Thus, in a configuration phase the respective functional scope can be set that is connected to the respective successful verification (verification stage). Thus, for example the configuration can be such that an emergency function can be put into operation even without verification (similar to emergency calling from a mobile phone without inputting PIN data), and a first function set of component K can be operated when there is successful type 1 verification, and a second function set of component K can be operated when there is successful type 2 verification. In this way, component K is controlled in modified fashion with regard to its technical function as a function of the result of the verification.

An important advantage of the system according to the present invention is that a traffic-related network, and in particular the commissioning of technical components K of a vehicle AK, can be realized essentially more securely in that the commissioning is possible only after successful verification.

In conclusion, it is to be noted that the description of the present invention and the exemplary embodiments are fundamentally not to be understood as being limiting with regard to a particular physical realization of the present invention. All features shown in connection with individual specific embodiment of the present invention and in the Figures can be used in the subject matter of the present invention in various combinations in order to simultaneously realize their advantageous effects. The various features and specific embodiments can also be combined.

For someone skilled in the art, it will in particular be obvious that the present invention can be used not only for roadway vehicles but also for other traffic-related components K. In addition, verification module V and component K can also be realized at other, or different, nodes of traffic network NW. The provision of a different sequence of the method steps is also within the scope of the present invention. In particular, confirmation signals can optionally be sent after each exchanged signal(s), or after exchanged signals that can be prespecified. Thus, it is for example also possible that, after an error-free reading in of the authentication data in read unit L (independent of the result of the verification), a confirmation signal is sent to an electronic instance. For example, the confirmation signal can be outputted at a user interface of authentication node AK or some other node. However, this is only optional. In a variant, the configuration can be such that an error signal is produced and/or outputted if the verification could not successfully be carried out. The reserved and stored data can be stored either locally or at a central location. The latter has the advantage that the data can be modified without changing the communication partners, and are also accessible by other instances. The definition of further precautions and regulations for a successful verified commissioning also lie within the scope of the present invention. Thus, it can for example be defined that a verified commissioning can be carried out only at particular time phases. It can also be preset that a verified commissioning can be carried out only by a specified circle of users.

The present invention is not limited by the features explained herein and shown in the Figures.

What is claimed is:

1. A telecommunication network in the area of traffic technology, comprising:
a multiplicity of nodes that each include a communication interface, and each of the nodes can be controlled electronically via the interface, at least one of the nodes being realized as an authentication node at which a read unit is situated, the read unit to read in authentication data of a mobile data carrier;
a verification module that exchanges data with the read unit and verify the authentication data read in by the read unit to produce a verification signal when there is a successful verification;
wherein at least one of the nodes being realized as a function node having a component that is to be controlled, the component being controlled to carry out a technical function when it has received the verification signal of the verification module.

2. The telecommunications network as recited in claim 1, wherein the authentication node is a vehicle.

3. The telecommunication network as recited in claim 1, wherein at least one of the verification module and the component, is not situated at the authentication node.

4. The telecommunication network as recited in claim 1, wherein the verification module and the component are situated at different nodes relative to one another, and the telecommunication network includes a control device that is situated at the same node as the component, and the control device is designed to put the component into operation in a verified manner in response to the received verification signal.

5. The telecommunication network as recited in claim 1, wherein the verification module and the component are situated at the same node, the same node being the function node.

6. An authentication node of a traffic-related telecommunication network, comprising:
a read unit to read in authentication data of a mobile data carrier; and
a verification interface that sends the authentication data read in by the read unit to a verification module, the verification module verifying the sent authentication data for operation of an electronically controllable component, and, in the case of a successful verification, to produce a verification signal that is used to put the electronically controllable component into operation in a verified manner.

7. The authentication node as recited in claim 6, wherein the authentication node is a vehicle.

8. The authentication node as recited in claim 6, wherein the verification module is situated at the authentication node.

9. The authentication node as recited in claim 6, wherein the verification module and the component are situated at the authentication node.

10. The authentication node as recited in claim 6, wherein a control device is situated at the authentication node, the control device to receive the verification signal of the verification module to put the component into operation in a verified manner in response to the received verification signal.

11. A method for commissioning an electronically controllable component of a telecommunication network in the area of traffic technology, the component requiring, for commissioning, a verification of authentication data that are to be acquired, and the component being situated at a function node of the traffic network, the method comprising:
positioning a mobile data carrier in an authentication node of the traffic network, the authentication node being a vehicle;
reading in authentication data of the mobile data carrier within the authentication node;
verifying the read in authentication data and, if verification is successful, producing a verification signal;
triggering a verified commissioning of the component if the verification signal is acquired one of: (i) at the component, or (ii) at a control device of the node at which the component is situated.

12. The method as recited in claim 11, wherein the component is used for wireless communication with a remote component, the remote component and the component being situated at different nodes of the telecommunication network.

13. The method as recited in claim 12, wherein the remote component one of: (i) acts directly as verification module, or (ii) interacts with an external verification module for the purpose of verification.

14. The method as recited in claim 12, wherein the verification signal includes a trigger signal that triggers a technical action at least one of: (i) at the vehicle, (ii) at the component, and/or at a remote component.

15. The method as recited in claim 11, wherein the component or the node at which the component is situated remain deactivated or can be operated only in a limited mode, if no verification signal can be produced or acquired.

16. The method as recited in claim 11, wherein the verification of the read in authentication data includes a comparison with stored, locked authentication data.

17. The method as recited in claim 11, wherein the verification of the read in authentication data includes:
acquiring at least one identification attribute of the user via sensors, and
comparing the acquired identification attributes with reference values that are stored on the mobile data carrier.
